(19) United States
(12) Patent Application Publication
(10) Pub. No.: US 2026/0294717 A1
(43) Pub. Date: Oct. 1, 2026

(54) Motorized Patient-Lift Medical Exam Table Device

(71) Applicant: Jerry Stephens, Rossville, GA (US)

(72) Inventor: Jerry Stephens, Rossville, GA (US)

(21) Appl. No.: 19/335,932

(22) Filed: Sep. 22, 2025

Related U.S. Application Data
(60) Provisional application No. 63/780,600, filed on Mar. 31, 2025.

(51) Int. Cl. A61G 7/16; A61G 7/10; A61G 13/00; A61G 13/08; A61G 13/12

(52) U.S. Cl. CPC A61G 7/16; A61G 7/1001; A61G 7/1019; A61G 7/1025; A61G 7/1044; A61G 7/1084; A61G 7/1088; A61G 7/1096; A61G 13/0018; A61G 13/08; A61G 13/121; A61G 13/1225; A61G 13/1245; A61G 13/1285

(57) ABSTRACT

A motorized patient-lift medical exam table device is provided. The device is configured to assist in the safe and ergonomic transfer of patients with limited mobility from external seating apparatuses to an examination surface of the device. The device comprises a frame having a head section, central platform section, and leg section. The head section is pivotally repositionable through a hinge mechanism allowing incline adjustments. The central platform section is vertically and laterally adjustable and actuated by at least one motor connected to lifting actuators. The platform may include a removable backrest, neck rest, and armrests to aid in patient transfer. During operation, the central platform can be manipulated such that it aligns with the height and position of an external seat such that the patient can be easily transferred onto the platform, which then retracts and elevates to form a flush examination surface with the head and leg sections.

### CROSS-REFERENCE TO RELATED APPLICATION

The present application claims priority to, and the benefit of, U.S. Provisional Application No. 63/780,600, which was filed on Mar. 31, 2025, and is incorporated herein by reference in its entirety.

### FIELD OF THE INVENTION

The present invention relates generally to the field of medical exam tables. More specifically, the present invention relates to a medical table with a movable platform designed to align with an external seating apparatus to receive the patient, wherein the platform then retracts and elevates to form a continuous and flush surface with head and leg sections to provide a continuous medical examination table surface. Accordingly, the present disclosure makes specific reference thereto. Nonetheless, it is to be appreciated that aspects of the present invention are also equally applicable to other like applications, devices, and methods of manufacture.

### BACKGROUND

Patients with impaired mobility frequently encounter significant challenges when attempting to transition from a wheelchair or similar seating apparatus to a traditional medical examination table. This transition often requires physical lifting by medical personnel, which introduces a risk of injury both to the patient and to the caregivers involved. In many clinical settings, staff availability may be limited, and reliance on manual lifting can be unsafe, inefficient, and unsustainable. Current examination tables lack integrated mechanisms to support autonomous or assisted lateral and vertical patient transfers. These tables often fail to accommodate the variability in wheelchair height and patient posture, making alignment difficult and further complicating the transfer process. As a result, clinical workflows are disrupted, appointments may be delayed, and patients may be denied dignified, safe, and equitable access to medical examinations. The absence of reliable transfer mechanisms also places undue physical strain on medical personnel, potentially contributing to workplace injuries and increased labor costs.

Therefore, there exists a long-felt need in the art for a motorized patient-lift medical exam table device that enables safe, lateral and vertical patient transfer without requiring manual lifting of the patient. There also exists a long-felt need in the art for a motorized patient-lift medical exam table device that provides flush alignment with various external seating apparatuses to ensure continuous surface support during transfer. Moreover, there exists a long-felt need in the art for a motorized patient-lift medical exam table device that reduces injury risks to both patients and healthcare personnel during examination table transitions.

The subject matter disclosed and claimed herein, in one embodiment thereof, comprises a motorized patient-lift medical exam table device. The device is configured to assist in the safe and ergonomic transfer of patients with limited mobility from external seating apparatuses to an examination surface of the device. The device comprises a frame having a head section, a central platform section, and a leg section. The head section is pivotally repositionable through a hinge mechanism allowing incline adjustments. Both the head and leg sections comprise padding enclosed within protective coverings and coated with antimicrobial and fluid-resistant materials. The central platform section is vertically and laterally adjustable and is actuated by at least one motor connected to lifting actuators. Lateral movement of the platform is provided through a separate or shared motor-actuator assembly, enabling movement of the platform relative to the longitudinal axis of the device. The platform may include a removable backrest, neck rest, and armrests to aid in patient transfer. During operation, the central platform can be manipulated such that it aligns with the height and position of an external seat such that the patient can be easily transferred onto the platform, which then retracts and elevates to form a flush examination surface with the head and leg sections.

In this manner, the motorized patient-lift medical exam table device of the present invention accomplishes all the forgoing objectives and provides a medical exam table with a vertically and laterally adjustable platform that allows seamless patient transfer from a seating apparatus to the table without manual lifting. This configuration addresses the risks associated with current manual transport methods and allows for ergonomic alignment with external seating apparatuses, thereby ensuring safer and more efficient transitions. As a result, the device minimizes physical strain on caregivers, enhances accessibility for patients with mobility limitations, and improves overall clinical workflow and patient safety.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a motorized patient-lift medical exam table device. The device is a medical examination table configured to facilitate safe and efficient patient transfer from external seating apparatuses such as but not limited to wheelchairs. The device is comprised of a frame that includes a pivotally adjustable head section, a central platform section, and a leg section. The head section is repositionable via a hinge mechanism that permits inclination adjustment. The head and leg sections are padded and enclosed in protective coverings that may include antimicrobial and fluid-resistant coatings.

The central platform section comprises a vertically and laterally adjustable motorized lifting platform integrated into or mounted on a secondary frame structure. At least one motor actuates movement of the platform, wherein the motor is operatively connected to one or more lifting actuators that provide vertical displacement over a defined height range to align with various seating apparatuses. Lateral movement of the central platform section is enabled through the same or an additional motor and actuator system, allowing translation perpendicular to the longitudinal axis of the device. This combined vertical and horizontal motion of the platform enables flush alignment with external seating surfaces for seamless patient transfer. The central platform section may further include a removable backrest and neck rest. Removable armrests are also included to assist in patient stability.

In operation, the central platform section is first lowered and extended laterally to align with an external seating apparatus. After a patient is transferred from the apparatus to the platform, the platform is retracted and elevated to form a continuous examination surface with the head and leg sections of the device.

The invention further includes a method of use comprising providing the device, adjusting the platform to align with external seating, positioning the patient on the platform, repositioning the platform to align with the examination surface, removing accessories if needed, and adjusting the head section inclination as required.

Accordingly, the motorized patient-lift medical exam table device of the present invention is particularly advantageous as it provides a medical exam table with a vertically and laterally adjustable platform that allows seamless patient transfer from a seating apparatus to the table without manual lifting. This configuration addresses the risks associated with current manual transport methods and allows for ergonomic alignment with external seating apparatuses, thereby ensuring safer and more efficient transitions. As a result, the device minimizes physical strain on caregivers, enhances accessibility for patients with mobility limitations, and improves overall clinical workflow and patient safety by overcoming the limitations of existing medical exam tables and patient transfer techniques known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a motorized patient-lift medical exam table device of the present invention in a flush position in accordance with the disclosed architecture;

FIG. 2 illustrates a perspective view of one potential embodiment of a motorized patient-lift medical exam table device of the present invention with the central platform section in a vertically lowered and a laterally extended position in accordance with the disclosed architecture;

FIG. 3 illustrates a perspective view of one potential embodiment of a motorized patient-lift medical exam table device of the present invention in a flush position with the armrest, backrest, and neck rest attached in accordance with the disclosed architecture; and

FIG. 4 illustrates a flowchart of a method of using one potential embodiment of a motorized patient-lift medical exam table device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a motorized patient-lift medical exam table device that enables safe, lateral and vertical patient transfer without requiring manual lifting of the patient. There also exists a long-felt need in the art for a motorized patient-lift medical exam table device that provides flush alignment with various external seating apparatuses to ensure continuous surface support during transfer. Moreover, there exists a long-felt need in the art for a motorized patient-lift medical exam table device that reduces injury risks to both patients and healthcare personnel during examination table transitions.

The present invention, in one exemplary embodiment, is comprised of a motorized patient-lift medical exam table device. The device is designed to enable safe and efficient transfer of patients from external seating apparatuses, including but not limited to wheelchairs, onto the device which functions as a medical exam table. The device is comprised of a frame that incorporates a pivotally adjustable head section, a central platform section, and a leg section. Inclination of the head section is adjustable via a hinge mechanism. Both the head and leg sections are padded and enclosed within protective coverings that may feature antimicrobial and fluid-resistant coatings.

The central platform section includes a motorized lifting platform that is vertically and laterally adjustable and is integrated into or mounted on a secondary frame structure. Movement of the platform is actuated by at least one motor, which is operatively connected to one or more lifting actuators configured to provide vertical displacement over a defined height range for alignment with various external seating apparatuses. Lateral movement is achieved through the same or an additional motor and actuator system, allowing translation perpendicular to the longitudinal axis of the device. The combined vertical and lateral adjustability of the platform enables flush alignment with seating surfaces to support seamless patient transfer. The platform section may also include a removable backrest and neck rest, along with detachable armrests for enhanced patient stability.

During use, the platform section is initially lowered and extended laterally to align with an external seating apparatus. Once the patient is transferred onto the platform, the section is retracted and elevated to form a continuous examination surface aligned with the head and leg sections of the device.

The invention also comprises a method of use involving providing of the device, adjustment of the platform to align with the seating apparatus, patient positioning on the platform, repositioning of the platform to align with the examination surface, removal of accessories if necessary, and adjustment of the head section inclination to meet procedural or patient needs.

As a result, the device offers significant advantages by incorporating a vertically and laterally adjustable platform that eliminates the need for manual patient lifting during transfer onto a medical exam table. This configuration reduces the physical burden on caregivers, aligns ergonomically with a wide range of seating apparatuses, and enables safer, more accessible, and more efficient patient handling. Consequently, the device addresses the limitations of existing examination tables and patient transfer methods by improving workflow and enhancing patient safety in clinical environments.

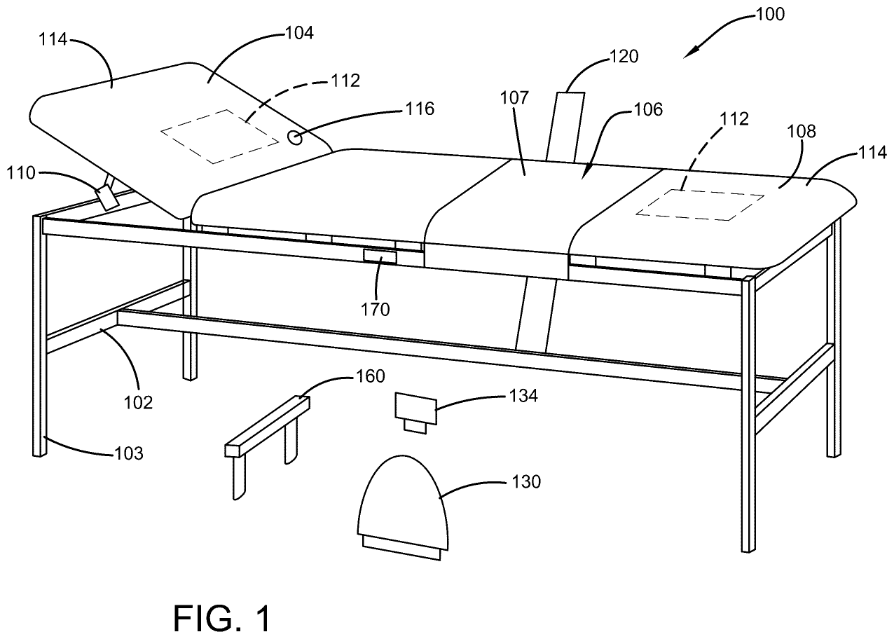

Referring initially to the drawings, FIG. 1 illustrates a perspective view of one potential embodiment of a motorized patient-lift medical exam table device 100 of the present invention in a flush position in accordance with the disclosed architecture. The device 100 is a medical exam table configured to assist in the safe and efficient transfer of patients, particularly individuals with limited mobility, from external seating apparatuses such as but not limited to wheelchairs, transport chairs, etc. onto the device 100 for medical examination. More specifically, the device 100 facilitates both lateral and vertical movement of a patient from the external seating apparatus onto the device 100, thereby eliminating the need for manual lifting by medical personnel. This transfer functionality may enhance accessibility, reduce physical strain on caregivers, and improve workflow efficiency in clinical environments.

The device 100 may be comprised of a frame 102 configured to support a patient during medical examinations. The frame 102 may be supported by legs 103 that may be any leg type such as but not limited to any combination of telescoping, fixed, retractable, height-adjustable, or wheeled legs. The frame 102 may include a head section 104, a central platform section 106, and a leg section 108. The head section 104 may be pivotally repositionable relative to the frame 102 via a hinge mechanism 110. The hinge mechanism 110 may be any hinge type such as but not limited to a manually actuated hinge, spring-assisted hinge, gas-spring hinge, motorized hinge, or hydraulic hinge assembly. The hinge mechanism 110 may permit adjustment of the head section 104 at incline angles ranging from 0 to 75 degrees relative to a horizontal axis of the device 100 to accommodate various clinical procedures and patient comfort preferences.

The head section 104 and the leg section 108 may be further comprised of padding 112 such as but not limited to any combination of a memory foam, closed-cell foam, viscoelastic gel, or layered polyurethane foam. The padding 112 may be enclosed within a protective covering 114 such as but not limited to any combination of a vinyl, synthetic leather, medical-grade silicone-coated fabric, or antimicrobial polyurethane-coated textile. The protective covering 114 may feature protective coatings 116 such as but not limited to any combination of antimicrobial coatings, fluid-resistant laminates, UV-resistant coatings, or abrasion-resistant polymer films.

The central platform section 106 may be comprised of a vertically and laterally adjustable lifting platform configured for motorized transfer of patients. The platform section 106 may be integrated into or mounted upon a frame structure 120. Movement of the section 106 may be actuated by at least one motor 122 of any type such as but not limited to any combination of a brushed DC motor, brushless DC motor, linear actuator motor, stepper motor, or servo motor, selected based on desired load-bearing capacity, operational speed, noise level, and precision.

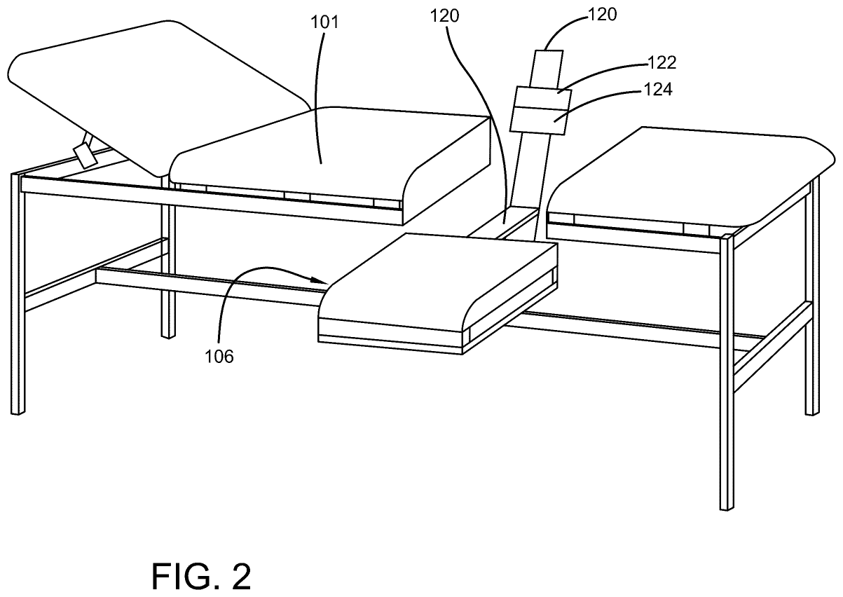

The motor 122 may be operatively connected to one or more lifting actuators 124 such as but not limited to any combination of single-stage or multi-stage telescopic columns, electrically driven screw-drive assemblies, scissor-lift linkages, pneumatic actuators, or hydraulic cylinders. The lifting actuators 124 may be configured to provide vertical displacement of the platform section 106 over a defined height range, as seen in FIG. 2, thereby enabling alignment with a wide range of external seating apparatuses and examination heights for ergonomic access by clinical personnel.

The section 106 may also be configured for lateral movement relative to a longitudinal axis of the device 100, as seen in FIG. 2, via the same motor 122 or a secondary motor 122 operatively connected to an actuator 124 that permits controlled translation in a direction perpendicular to the top edge 101 of the device 100. In one embodiment, a single motor 122 may be configured to actuate both vertical and lateral movements through a coordinated mechanical linkage or drive system. In another embodiment, two distinct motors 122 may independently drive the vertical and lateral actuation mechanisms separately. The combination of vertical and horizontal actuation may enable a patient to be seamlessly transferred from a lateral position on an external apparatus onto the section 106 of the device 100, forming a flush and continuous support surface for examination.

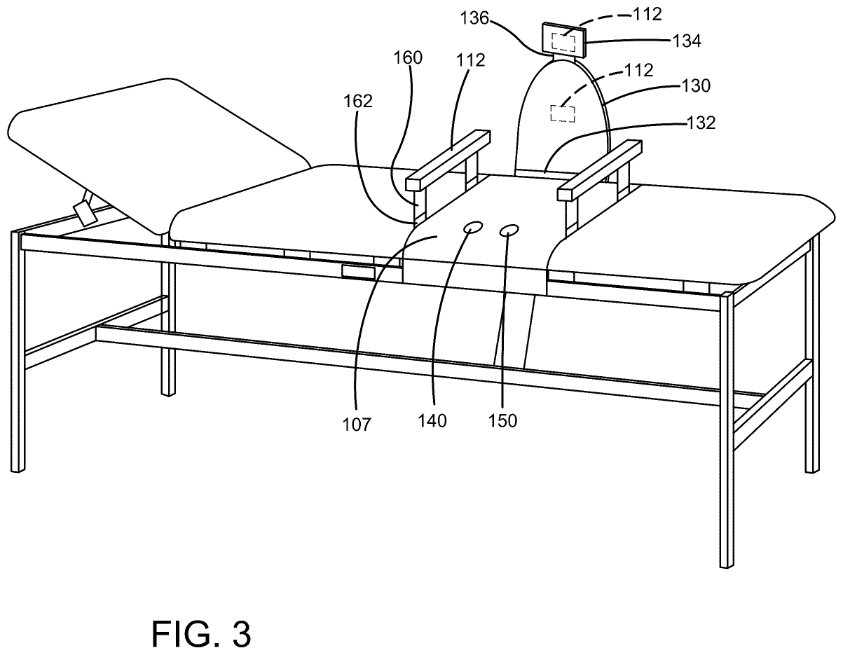

The section 106 may further include a removable backrest 130, as seen in FIG. 3, that may be removably attached to the section 106 via fasteners 132 such as but not limited to snap-locks, threaded inserts, magnetic couplers, quick-release clamps, etc. The backrest 130 may be further comprised of a detachable neck rest 134 attached to the backrest 130 via at least one fastener 136 such as but not limited to hook-and-loop fasteners, screws, locking pins, slide-in brackets, etc. Both the backrest 130 and the neck rest 134 may be comprised of padding 112 and enclosed within a protective covering 114 having one or more protective coatings 116, such as but not limited to those described above for the head section 104.

In addition, the section 106 may include one or more removable armrests 160 configured to assist in patient support and stability during transfer and examination, as seen in FIG. 3. The armrests 160 may be removably attached to the section 106 via fasteners 162 such as but not limited to any combination of slotted brackets, locking pins, threaded knobs, or quick-release latches. The armrests 160 may further include padding 112 and protective coverings 114 and coatings 116 similar to those described for the backrest 130.

The top surface 107 of the section 106 may be comprised of a low-friction material to facilitate the sliding of the patient across the section 106. Example materials for the top surface 107 may include but are not limited to any combination of high-density polyethylene (HDPE), polytetrafluoroethylene (PTFE), ultra-high-molecular-weight polyethylene (UHMWPE), or coated aluminum. The surface 107 may optionally include a surface coating 140 such as but not limited to any combination of silicone-based lubricant coatings, anti-microbial polymer coatings, or stain-resistant hydrophobic films. The surface 107 may also be comprised of an optional surface texture 150 such as but not limited to any combination of micro-patterned embossments, channeling, etc., to reduce friction while maintaining enough traction to minimize unintended patient sliding.

In operation, the section 106 may be initially lowered vertically and extended laterally outward from the frame 102, as seen in FIG. 2, thereby aligning with the external seating apparatus. A patient may be positioned on the section 106, after which the section 106 may be retracted laterally and raised vertically to form a flush and contiguous examination surface aligned with the head section 104 and leg section 108. The vertical and lateral motion may occur in a continuous or incremental manner. This may reduce or eliminate the need for manual lifting, minimize fall risk, and improve overall patient safety and accessibility.

The device 100 may further comprise a control interface 170 configured to operate the movement of the section 106 via the motor 122 and the lifting actuator 124. The control interface 170 may be in any form such as but not limited to a handheld remote control, integrated touch panel, foot pedal control, voice-activated interface, or mobile application interface.

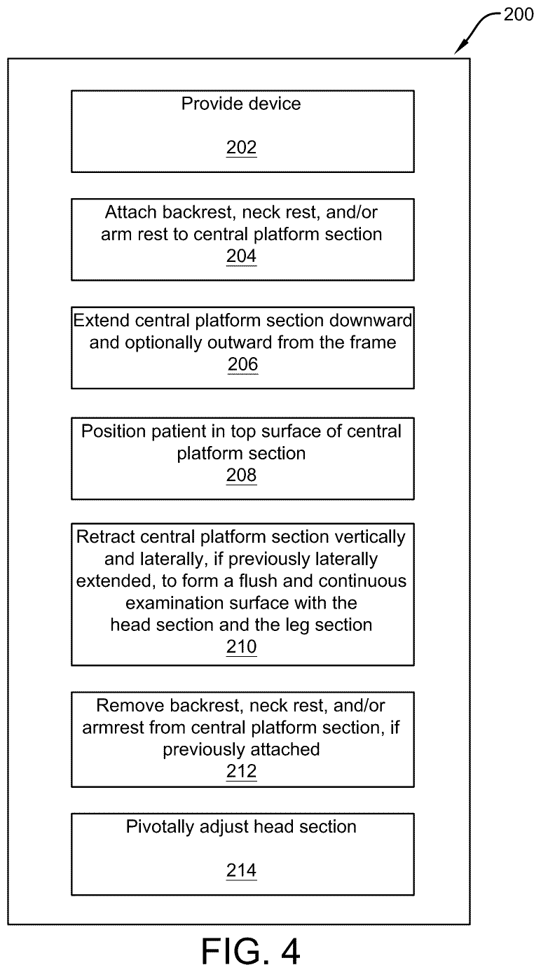

The present invention is also comprised of a method of using 200 the device 100, as seen in FIG. 4. First, a device 100 is provided comprised of a frame 102 supported by legs 103 and further comprised of a head section 104, a central platform section 106, and a leg section 108, wherein the central platform section 106 is vertically and laterally adjustable via at least one motor 122 operatively connected to at least one lifting actuator 124 [Step 202]. Then, one or more accessories including a backrest 130, a neck rest 134, and one or more armrests 160 can be removably attached to the central platform section 106 via corresponding fasteners 132, 136, and 162, respectively, based on patient needs and support requirements [Step 204]. Next, the central platform section 106 can be extended downward from the frame 102 to align with the height of an external seating apparatus and can optionally be extended laterally outward from the frame 102 based on the spatial orientation of the patient transfer scenario [Step 206]. Then, a patient can be positioned onto the top surface 107 of the central platform section 106 [Step 208]. After the patient is positioned, the central platform section 106 can be retracted laterally, if previously extended, and raised vertically such that the central platform section 106 forms a flush and continuous examination surface aligned with the head section 104 and leg section 108 [Step 210]. Then, the backrest 130, neck rest 134, and/or armrests 160 can be removed from the central platform section 106 via disengagement of their respective fasteners 132, 136, and 162 [Step 212]. Next, the head section 104 can be pivotally adjusted via a hinge mechanism 110 as desired to an incline angle suitable for the intended clinical procedure or patient comfort [Step 214].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “motorized patient-lift medical exam table device” and “device” are interchangeable and refer to the motorized patient-lift medical exam table device 100 of the present invention.

Notwithstanding the foregoing, the motorized patient-lift medical exam table device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the motorized patient-lift medical exam table device 100 as shown in the FIGS. are for illustrative purposes only, and that many other sizes and shapes of the motorized patient-lift medical exam table device 100 are well within the scope of the present disclosure. Although the dimensions of the motorized patient-lift medical exam table device 100 are important design parameters for user convenience, the motorized patient-lift medical exam table device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A motorized patient-lift medical exam table device comprising:
a frame comprised of a leg;
a head section pivotally attached to the frame via a hinge mechanism;
a leg section;
a frame structure comprised of a motor operatively connected to a lifting actuator;
a central platform section attached to the frame structure;
wherein the lifting actuator is configured to provide a vertical displacement of the central platform section relative to the frame; and
further wherein the motor is further configured to provide a lateral displacement of the central platform section relative to the frame.

2. The motorized patient-lift medical exam table device of claim 1, wherein the hinge mechanism is comprised of a manually actuated hinge, a spring-assisted hinge, a gas-spring hinge, a motorized hinge, or a hydraulic hinge assembly.

3. The motorized patient-lift medical exam table device of claim 1, wherein the head section and the leg section are comprised of a padding.

4. The motorized patient-lift medical exam table device of claim 1, wherein the lifting actuator is comprised of a single-stage telescopic column, a multi-stage telescopic column, an electrically driven screw-drive assembly, a scissor-lift linkage, a pneumatic actuator, or a hydraulic cylinder.

5. The motorized patient-lift medical exam table device of claim 1 further comprised of a control interface.

6. The motorized patient-lift medical exam table device of claim 5, wherein the control interfaces actuates the motor.

7. The motorized patient-lift medical exam table device of claim 5, wherein the control interfaces actuates the lifting actuator.

8. The motorized patient-lift medical exam table device of claim 5, wherein the control interface is comprised of a remote control, a touch panel, a foot pedal, a voice-activated interface, or a mobile application interface.

9. A motorized patient-lift medical exam table device comprising:
a frame comprised of a leg;
a head section pivotally attached to the frame via a hinge mechanism;
a leg section;
a frame structure comprised of a motor operatively connected to a lifting actuator;
a central platform section attached to the frame structure, wherein the lifting actuator is configured to provide a vertical displacement of the central platform section relative to the frame, and further wherein the motor is configured to provide a lateral displacement of the central platform section relative to the frame;
a backrest attached to the central platform section via a first fastener; and
a neck rest attached to the backrest via a second fastener.

10. The motorized patient-lift medical exam table device of claim 9 further comprised of an armrest.

11. The motorized patient-lift medical exam table device of claim 10, wherein the armrest is attached to the central platform section via a third fastener.

12. The motorized patient-lift medical exam table device of claim 9, wherein the backrest is comprised of a padding.

13. The motorized patient-lift medical exam table device of claim 9, wherein the neck rest is comprised of a padding.

14. The motorized patient-lift medical exam table device of claim 10, wherein the arm rest is comprised of a padding.

15. The motorized patient-lift medical exam table device of claim 9 further comprised of a control interface.

16. The motorized patient-lift medical exam table device of claim 15, wherein the control interfaces actuates the motor.

17. The motorized patient-lift medical exam table device of claim 15, wherein the control interfaces actuates the lifting actuator.

18. The motorized patient-lift medical exam table device of claim 15, wherein the control interface is comprised of a remote control, a touch panel, a foot pedal, a voice-activated interface, or a mobile application interface.

19. The motorized patient-lift medical exam table device of claim 9, wherein a top surface of the central platform section is comprised of a texture.

20. A method of using a motorized patient-lift medical exam table device, the method comprising the following steps:
providing a motorized patient-lift medical exam table device comprised of a frame, a head section, a central platform section, and a leg section, wherein the central platform section is vertically and laterally adjustable via a motor operatively connected to a lifting actuator;
adjusting the central platform section downward from the frame to align with a height of an external seating apparatus and adjusting the central platform section laterally outward from the frame;
positioning a patient onto a top surface of the central platform section; and
retracting the central platform section laterally back into the frame and raising the central platform section vertically such that the central platform section forms a flush and continuous examination surface aligned with the head section and the leg section.
